(19) United States
(12) Patent Application Publication
(10) Pub. No.: US 2026/0313224 A1
(43) Pub. Date: Oct. 8, 2026

(54) USER INTERFACE, METHOD, AND SYSTEM FOR ENHANCING CAPTURE OF SIGNALS FROM A FRONT-FACING CAMERA

(71) Applicant: NURALOGIX CORPORATION, Toronto (CA)

(72) Inventors: Talal HAJ BAKRY, Mississauga (CA); Rajas Ajit SAMBHARE, Toronto (CA); Phil LEVY, Brampton (CA)

(21) Appl. No.: 19/481,333

(22) PCT Filed: May 8, 2024
(86) PCT No.: PCT/CA2024/050625

§ 371 Date: Nov. 4, 2025

Related U.S. Application Data
(60) Provisional application No. 63/501,142, filed on May 9, 2023.

(51) Int. Cl. H04N 23/60; H04N 23/74

(52) U.S. Cl. CPC H04N 23/64; H04N 23/74

(57) ABSTRACT

Provided is a user interface, method, and system for enhancing capture of signals from a front-facing camera. The method including: iteratively performing for a predetermined period: displaying one or more user elements to a user on a display; displaying a backlighting color at approximately maximum brightness at ancillary portions of the display, the ancillary portions comprising areas of the display that do not include the one or more user elements; receiving data captured of the user from the front-facing camera; and displaying representations of the data captured of the user within the one or more user elements; and outputting the data captured of the user.

### TECHNICAL FIELD

The following relates generally to user interface; and more specifically to a user interface, method, and system for enhancing capture of signals from a front-facing camera.

### BACKGROUND

As image sensors, such as those located on smartphones, become more prevalent, downstream processing tasks can be performed with the captured data. In an example, certain image processing tasks based on images/videos received from a front-facing camera. However, in order to accomplish such tasks, capturing good data with such sensors becomes highly desirable.

### SUMMARY

In an aspect, there is provided a method for enhancing capture of signals from a front-facing camera, the method comprising: iteratively performing for a predetermined period: displaying one or more user elements to a user on a display; displaying a backlighting color at approximately maximum brightness at ancillary portions of the display, the ancillary portions comprising areas of the display that do not include the one or more user elements; receiving data captured of the user from the front-facing camera; and displaying representations of the data captured of the user within the one or more user elements; and outputting the data captured of the user.

In a particular case of the method, the one or more user elements are substantially oblong shaped.

In another case of the method, the one or more user elements are oval shapes.

In yet another case of the method, the backlighting color is a solid color with greater brightness compared to other colors displayable by the display.

In yet another case of the method, displaying the backlighting color at approximately maximum brightness at ancillary portions of the display comprises displaying the backlighting color with high-dynamic range (HDR).

In yet another case of the method, displaying a backlighting color at approximately maximum brightness at ancillary portions of the display comprises dynamically adjusting brightness of the display and color temperature in the ancillary portions based on lighting condition and skin tone of the user.

In yet another case of the method, the method further comprising, during each iteration, displaying to the user instructions for placement of the front-facing camera in front of the user based on position and distance of the user relative thereto.

In yet another case of the method, the method further comprising outputting to the user a measure of signal quality determined from the data received from the front-facing camera.

In yet another case of the method, outputting to the user the measure of signal quality determined from the data received from the front-facing camera comprises displaying visual representations of the measure of signal quality.

In yet another case of the method, the visual representations of the measure of signal quality are displayed in the ancillary portion of the display.

In another aspect, there is provided a system for enhancing capture of signals from a front-facing camera, the system comprising: a processor; an interface operatively connected to the processor, wherein the interface is configured to receive input from the front-facing camera and to output information to a display; and a storage medium operatively connected to the processor, the non-transitory readable storage medium stores instructions executable by the processor to: iteratively: display one or more user elements to a user on the display; display a backlighting color at approximately maximum brightness at ancillary portions of the display, the ancillary portions comprising areas of the display that do not include the one or more user elements; receive data captured of the user from the front-facing camera; and display representations of the data captured of the user within the one or more user elements; and output the data captured of the user.

In a particular case of the system, the one or more user elements are substantially oblong shaped.

In another case of the system, the one or more user elements are oval shapes.

In yet another case of the system, the backlighting color is a solid color with greater brightness compared to other colors displayable by the display.

In yet another case of the system, displaying the backlighting color at approximately maximum brightness at ancillary portions of the display comprises displaying the backlighting color with high-dynamic range (HDR).

In yet another case of the system, displaying a backlighting color at approximately maximum brightness at ancillary portions of the display comprises dynamically adjusting brightness of the display and color temperature in the ancillary portions based on lighting condition and skin tone of the user.

In yet another case of the system, during each iteration, instructions for placement of the front-facing camera in front of the user is displayed to the user based on position and distance of the user relative thereto.

In yet another case of the system, a measure of signal quality is outputted to the user that is determined from the data received from the front-facing camera.

In yet another case of the system, outputting to the user the measure of signal quality determined from the data received from the front-facing camera comprises displaying visual representations of the measure of signal quality.

In yet another case of the system, the visual representations of the measure of signal quality are displayed in the ancillary portion of the display.

### BRIEF DESCRIPTION OF THE DRAWINGS

The features of the invention will become more apparent in the following detailed description in which reference is made to the appended drawings wherein:

FIG. 1 shows a system for enhancing capture of signals from a front-facing camera, in accordance with an embodiment;

FIG. 2 shows an exemplary computing environment of the system of FIG. 1;

FIG. 3 shows a method for enhancing capture of signals from a front-facing camera, in accordance with an embodiment;

FIG. 4 illustrates an example user interface implementation of the system of FIG. 1 to capture signals from the face of a user;

FIG. 5 illustrates the example user interface of FIG. 4;

FIG. 6 illustrates another example user interface implementation of the system of FIG. 1 to capture signals from the face of a user; and

FIG. 7 illustrates the example user interface of FIG. 6.

### DETAILED DESCRIPTION

Embodiments will now be described with reference to the figures. For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following relates generally to a user interface; and more specifically to a method and system for enhancing capture of signals from a front-facing camera.

The detection of signals in an image, image sequence, or video involves the identification and extraction of patterns and features from the captured data and processing such patterns and features to provide a desired output. For example, using computer vision techniques to analyze image data, such as a still image or a set of image frames within a video recording, and extract relevant information for further processing.

Various techniques can be used to determine signals located in captured images and videos from a camera; for example, edge detection, object recognition, color detection, transdermal imaging, or the like. Many of such techniques involve identifying changes or differences in brightness or color within a set of images to identify and/or track specific elements, shapes, or patterns. Furthermore, various machine learning models can be used to identify certain features or signals of interest in the captured image(s). In some cases, detection of signals can require quick-changing elements or other elements that can be hard to track. In most cases, a major success factor for any given technique is quality of data received from the captured images or video.

Generally, data gathering for signal detection depends on the strength and quality of signals received by a sensor. For images and video, since camera sensors receive light signals and convert them into electrical signals, the strength and quality of the received light signals can play a significant role as to whether sufficient light is captured to ultimately determine high-quality signals. In some cases, cameras can include specific ranges of wavelength or amplitude thresholds or ranges for optimal capture of images. Generally, such ranges are targeted for well-lit environments. In other words, in order to capture the best images by such devices, having sufficient light strike the sensor is paramount.

Generally, applications that utilize signal determination from captured images and videos rely on users to ensure that the available lighting environment are suitable. These applications may also prompt users to use a supplementary (external) light source to illuminate their face or body when necessary. However, many users may not have access to an external light source and/or their ability to control the ambient lighting may be restricted when using the application.

Sensors and cameras of various computing devices and smartphones can be placed on several different locations on the device. A front-facing sensor or camera is typically placed on or next to a display screen where the sensor or camera can be used to capture an image or video and the display can immediately display the captured image or video back to the user. Moreover, front-facing sensors or cameras can provide readily accessible hardware for adoption of real-time signal detection and processing with insignificant costs for a common user of a consumer mobile device or computer. The front-facing sensors or cameras can be used, in some cases, to provide real-time feedback of signal determination from captured images or videos.

In many circumstances, under lower levels of ambient light, consumer-grade front-facing cameras do not provide high-levels of contrast or light capture to provide a sufficient signal-to-noise ratio for downstream signal determination.

In some approaches, such as for the capture of a single image using the front-facing camera, the display of the device can display a fully white screen for a very short duration while the image is being captured; in order to increase ambient light and provide a better opportunity for capturing reflections of the light at the camera sensor. While such approaches may generally be suitable for capturing of a single still image or an extremely short video using the front-facing camera, such approaches are not suitable for scenarios that require capture of images or videos over a longer timescale. In most cases, such longer timescales are generally necessitated for applications where the captured images are later used for downstream signal determinations.

Advantageously, the present embodiments overcome the substantial problems of capturing images and videos from a front-facing camera for signal determination in non-ideal lighting conditions.

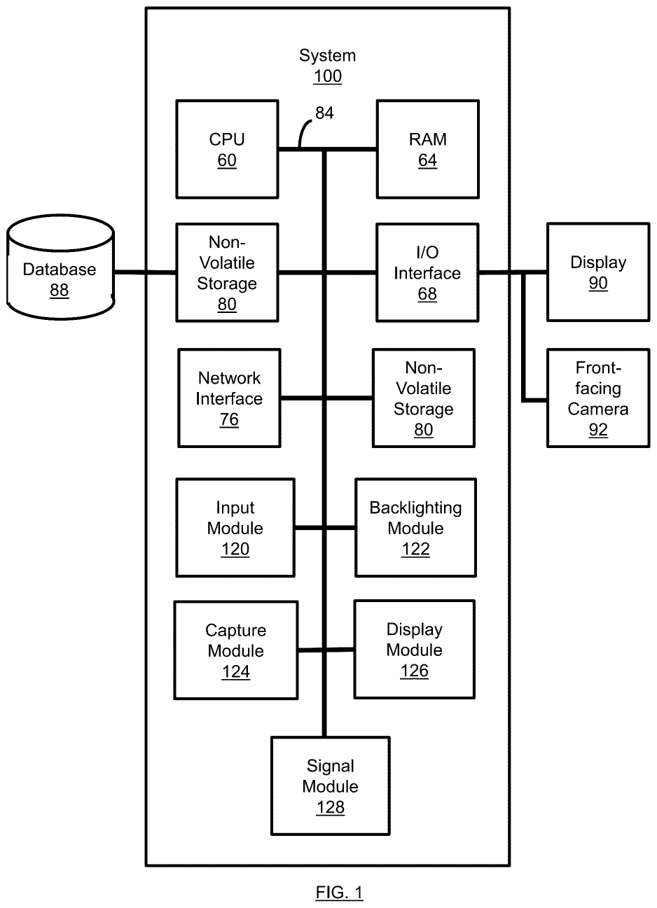

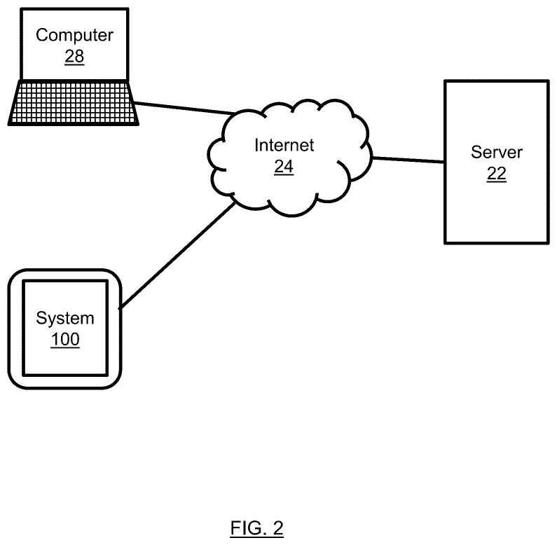

Referring now to FIG. 1, a system 100 for enhancing capture of signals from a front-facing camera is provided, in accordance with an embodiment, is shown. As shown in FIG. 2, in an exemplary computing environment, the system 100 can be in communication with other computing devices; for example, another computer 28 or a server 22. Other computing devices can also include, for example, tablet computers, smart watches, IOT devices, cameras, or the like. The system 100 can communicate with the other computing devices locally, or remotely, over a network; for example, the Internet 24.

FIG. 1 shows various physical and logical components of the system 100. As shown, the system 100 has a number of physical and logical components, including a central processing unit (“CPU”) 60, random access memory (“RAM”) 64, an input/output (I/O) interface 68, a network interface 76, non-volatile storage 80, and a local bus 84 enabling CPU 60 to communicate with the other components. CPU 60 can execute an operating system and one or more conceptual modules, as described herein. RAM 64 provides relatively responsive volatile storage to CPU 60. The I/O interface 68 enables input to be communicated to the system 100, for example from a user via a keyboard and mouse. The I/O interface 68 also enables receiving captured images and videos from one or more sensors, such as, a front-facing camera 92. The I/O interface 68 can also output information to output devices, such as the display 90 and/or speakers. The network interface 76 permits communication with other systems, such as computing devices 28 and server 22. Non-volatile storage 80 stores the operating system and programs, including computer-executable instructions for implementing the conceptual modules, as well as any data used by these services. The non-volatile storage 80 can interface with an internal or external database 88 as a longer-term store of data. During operation of the system 100, the operating system, the programs and the data may be retrieved from the non-volatile storage 80 and placed in RAM 64 to facilitate execution.

In an embodiment, the system 100 is configurable to execute a number of conceptual modules, for example, a signal module 120, a backlighting module 122, a visualization module 124, and a capture module 126.

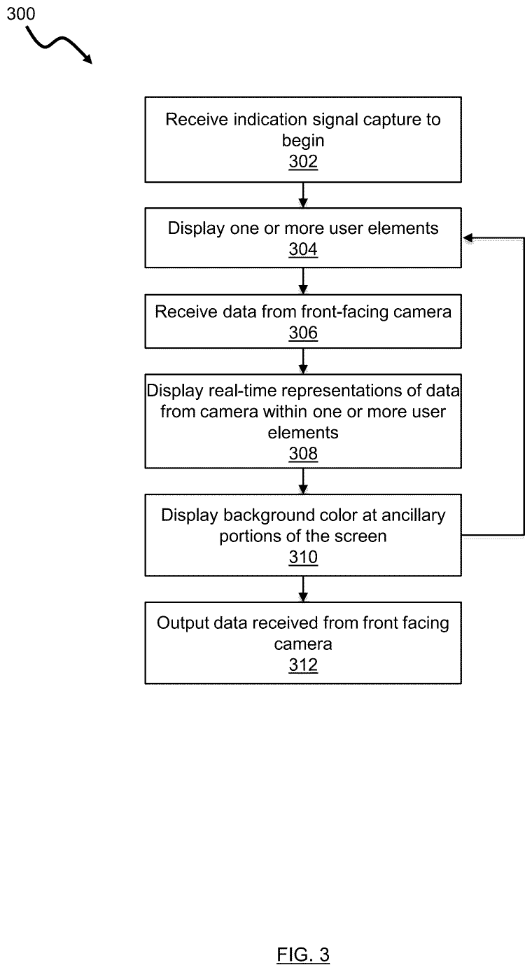

FIG. 3 illustrates a flowchart for a method 300 for enhancing capture of signals from a front-facing camera, in accordance with an embodiment.

At block 302, the input module 120 receives an indication that signal capture is to begin; for example, from a user via the I/O interface 68, via a command received over the network interface 76, or via a set of instructions provided by the database 88.

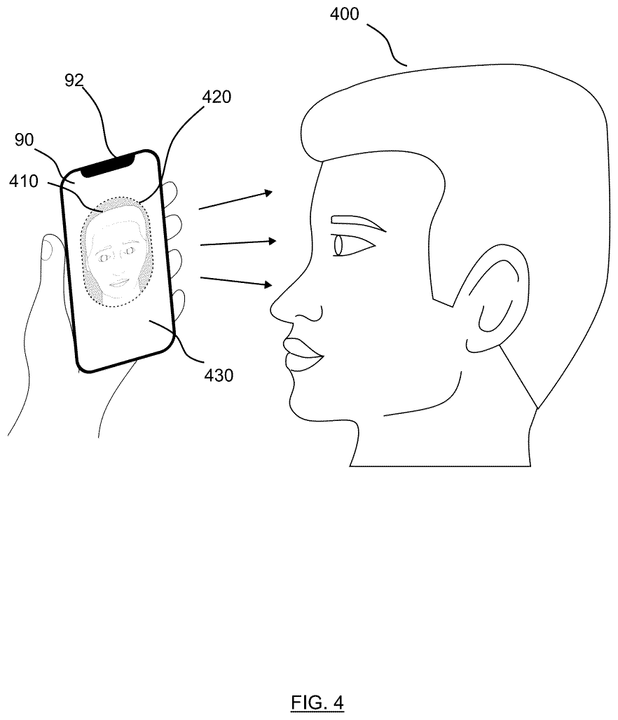

At block 304, the display module 126 displays one or more user elements 420 to a user on the screen of the display 90, via the I/O interface 68. The one or more user elements 420 used to direct the user to point the forward-facing camera 92 towards their face. It is understood that in other embodiments, the image capturing screen is used to direct the user to point the camera 92 at other portions of their body. In a preferable embodiment, as illustrated in FIGS. 4 to 7, where the user is to point the forward-facing camera 92 towards their face, the one or more user elements 420 comprises an oval shape.

At block 306, the capture module 124 receives data from the front-facing camera 92, received via the I/O interface 68, representative of images being captured of the user. In some cases, the data can be received at a given rate, for example, at 60 frames per second for a video. In further cases, data can be received at any suitable rate.

At block 308, the display module 126 displays real-time representations 410 of the images being captured by the front-facing camera 92. The real-time representations 410 are displayed within the confines of the one or more user elements 420. While the present embodiments generally describe use of a visible light front-facing camera 92, it is understood that any suitable front-facing sensor can be used and displayed to the user for real-time representations 410; such as, an infrared camera, a proximity sensor, or the like.

At block 310, while the display module 126 displays the real-time representations 410 of images being captured by the front-facing camera 92, the backlighting module 122 displays a backlighting color, at or around maximum brightness, at ancillary portions 430 of the screen to provide front-facing light to reflect off the user and be captured by the front-facing camera 92. The ancillary portions 430 comprise those areas that are not displaying the one or more user elements 420. In most cases, the backlighting color is a solid color that provides at least above average brightness compared to other colors that could be displayed by the display 90; for example, white or amber. In further cases, any suitable color or gradient of color can be used that is appropriate for providing front-facing light to reflect off the user. In some cases, where the screen permits, the display 90 can display the backlighting color at the ancillary portions 430 with high-dynamic range (HDR) to potentially achieve maximum brightness. In some cases, the screen's brightness, and the color temperature in the ancillary portions 430, can be dynamically adjusted based on determining values that provide the greatest signal capture for a given lighting condition and a user's skin tone.

Blocks 304 to 310 are repeated for a predetermined period; wherein during such period the display module 126 displays the representations, the backlighting module 122 displays the backlighting color, and the capture module 124 receives data from the front-facing camera 92. In some cases, the predetermined period can be a set length of time (for example, 30 seconds). In other cases, the predetermined period can be until a predetermined quantity of sufficient-quality data has been received for downstream signal processing. In some cases, a remaining time until the predetermined period ends can be displayed to the user on the screen.

At block 312, the signal module 128 outputs the data received from the front-facing camera 92 for signal processing by the CPU 60, or to the network interface 76 or the database 88.

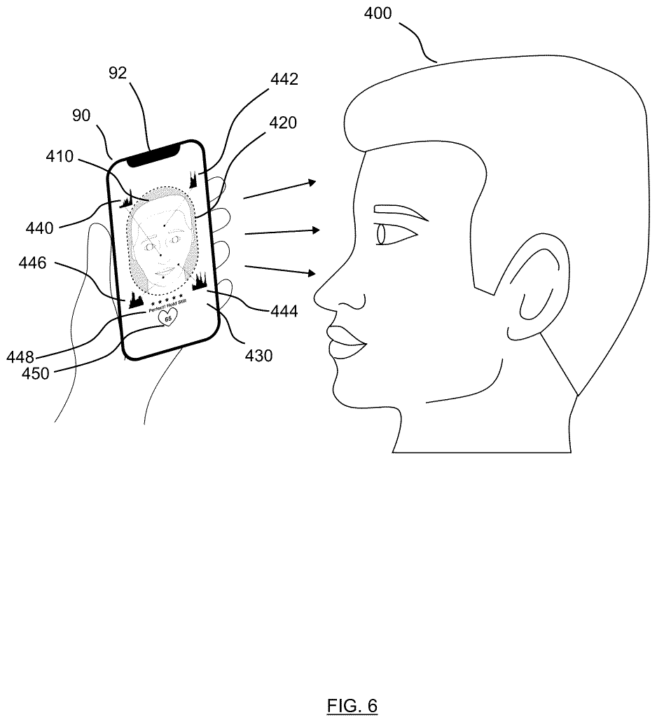

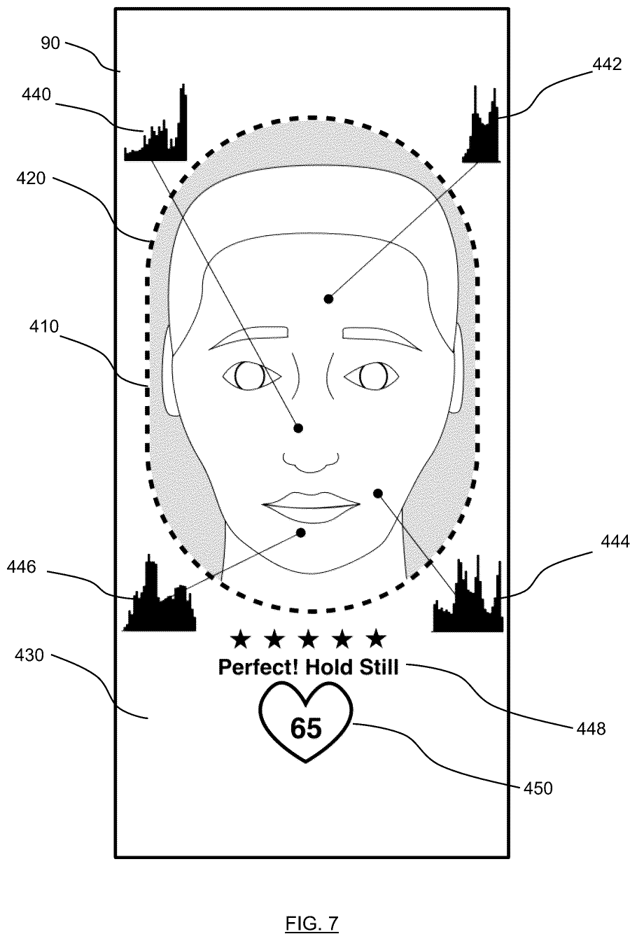

In some cases, the capture module 124 can determine a measure of signal quality from the data received from the front-facing camera 92. The signal quality can be determined, for example, by determining a signal to noise ratio (SNR), a temporally-averaged signal to noise ratio, determining amplitudes, or the like. In some cases, this measure can also be displayed to the user on the screen. In some cases, the measures of signal quality can be converted to a temporal visual representation and shown to the user on the screen; for example, as illustrated in the histograms shown in FIGS. 6 and 7. In other cases, the measures of quality can be converted to an audio output; for example an a series or combinations of audio prompts or jingle tones to explain the current status of signal quality or to provide end user recommendations for improving the signal quality.

In some cases, the ancillary portions 430 can be used to provide other information to the user; for example, real-time feedback on the features of the signal capture, such as sufficiency of light, signal to noise ratio, time remaining required for signal capture, or any other suitable information.

The present embodiments can be used for any suitable approach for signal processing. For example, transdermal optical imaging (TOI), as described herein, machine learning processing, or the like.

In some cases, the display module 126 can determine a position and distance of the user relative to the front-facing camera 92, for example, using the location and distance between the user's eyes, in order to provide instructions to the user for placement of the camera 92 in front of their face.

Generally, for high-quality signal capture from received images, the user should be close enough to the screen for sufficient light to be reflected off the user and captured by the camera 92. The present inventors determined that, advantageously, a substantially oblong shaped user element 420 guides users to bring their face close enough to the front-facing camera 92 for higher quality signal capture by allowing the screen to provide sufficient light to reach their face. The present inventors determined that the oblong shape, such as a substantially elliptical shape, provides substantially better urging for users to bring the camera 92 closer to their face than other shapes of the user element 420 that were tried, such as circles.

The oblong shaped user element 420 provides stronger visual cues to guide the user to move the face closer to the screen, and thus, front-facing camera. Having the user's face in very close proximity also amplifies the benefits of the backlighting color; due to the inverse square law of light intensity.

It is understood that any suitable shape for the user element 420 can be used in combination with the backlighting color of the ancillary portions; however, the present inventors determined that there were particular advantages of the oblong shape. In further cases, the one or more user elements 420 can have any other suitable shape or pattern; for example, an egg shape, an elongated version of another shape, a human face shape, or the like.

Advantageously, the present embodiments provide a relatively simple and elegant approach to address the problem of insufficiently captured images for signal determination. Displaying real-time image representations of the captured images allows a user to adjust the position and direction of the front-facing camera to accurately capture their face for the duration of the image capture procedure; which in some cases, can be more than 30 seconds in length. While, at the same time, using the unused portions of the screen to provide additional brightness to enhance signal capture by providing more light to reflect off the user and strike the camera.

The present inventors conducted example experiments to verify the substantial advantages of the present embodiments. The example experiments illustrate that the present embodiments provides a measurably, quantifiable, and demonstratable improvement on signal determination success rate.

In the example experiments, the signal processing that was performed was contactless optical-based techniques for measuring facial blood flow; using Transdermal Optical Imaging and Remote Photoplethysmography (rPPG). These processing techniques require adequate lighting of data received by the camera to attain a high-quality measurement. The example experiments implemented a particular type of rPPG referred to as Transdermal Optical Imaging (TOI). TOI is a non-invasive imaging technique that involves the use of light to capture images of blood flow and oxygenation levels underneath the skin. TOI has a wide range of applications, including monitoring blood flow in skin grafts and flaps, assessing burn wounds, detecting early signs of skin cancer, and measuring changes in blood flow and oxygenation levels in response to physical activity or cognitive tasks.

Some examples of implementing TOI uses a special type of camera, known as a transdermal optical imager, which emits light of specific wavelengths that can penetrate the skin. By analyzing the amount of light that is scattered and absorbed, the camera can produce high-resolution images of blood flow and oxygenation levels in real-time. In other cases, such as in the example experiments, front-facing cameras on consumer mobile devices can be used to perform TOI determinations; however, in such cases, the ambient light may not be sufficient for TOI determinations, and most consumer mobile devices do not include a front-facing flash or light.

The example experiments involved performing TOI determinations with consumer mobile devices for a number of users over three different iterations. In the first iteration, TOI was performed with a circular user element showing the current camera capture within the element. In this first iteration, the application had a typical background that is darker in color and brightness; because typically application designers would want to have the user focus their attention on the capture of their face by the camera. In a second iteration, TOI was performed using an oblong shaped user element and the typical backlighting color. In a third iteration, TOI was performed using the oblong shaped user element and a backlighting color for the ancillary portions.

The results of the example experiments showed that the first iteration had an average of 6% of the data received from the captured images being able to be used for determination of a TOI signal. The results of the example experiments showed that the second iteration had an average of 55% of the data received from the captured images being able to be used for determination of a TOI signal. The results of the example experiments showed that the third iteration had an average of 85% of the data received from the captured images being able to be used for determination of a TOI signal. Indicating that the present embodiments provide, on average, a substantial improvement in data received for signal processing.

The example experiments showed that with the oblong shape on the screen, users will intuitively hold their faces closer to the screen and without any further instructions; thus, receiving sufficient light from the backlit background ancillary portions. All of which resulted in better quality light received by the camera for the TOI determination.

FIGS. 4 to 7 show illustrative and non-limiting examples of a user interface implemented by the system 100.

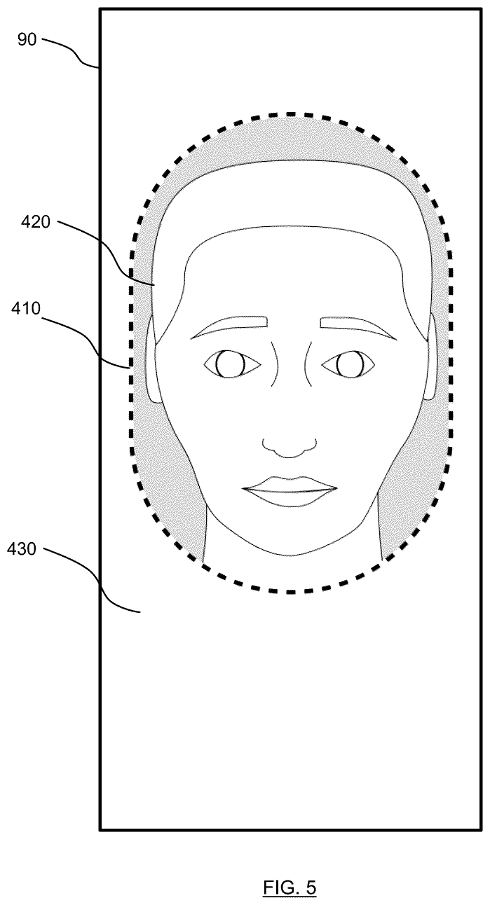

FIG. 4 illustrates a perspective view of the system 100 in an example where the system 100 captures images of a user 400. FIG. 5 illustrates the display 90 as the system 100 performs blocks 304 to 310. In this example, the system 100 receives signals from the front-facing camera 92 while the front-facing camera 92 sensor is directed at the user's face 400. An oblong oval shaped user element 410 is displayed on the display 90 with real time captured images 420 of the user 400 displayed within the user element 410. The ancillary portions 430 around the user element 410 display a solid backlighting color of white with maximum brightness and HDR.

FIG. 6 illustrates a perspective view of another example of the system 100 as it captures images of the user 400. FIG. 7 illustrates the display 90 as the system 100 performs blocks 304 to 310 for this additional example. In the example illustrated in FIGS. 6 and 7, the ancillary portions 430 include further information. In this case, the further information includes histograms 440, 442, 444, and 446 showing the quality of data being received by the camera. The further information also includes instructions/feedback 448 for the user for the image capture process and real-time data 450 (in this case, heart rate). As shown, even where further information is provided in the ancillary portions 430, a substantial fraction of the ancillary portions 430 (e.g., greater than 50%) is the backlighting color to provide the illumination described herein.

While the present examples generally show a single user element 420, in further cases, the display 90 can show multiple user elements; for example, where there are more than one front-facing sensor and/or camera directed at the user, the capture from each sensor and/or camera can be displayed within a respective user element 420.

Although the invention has been described with reference to certain specific embodiments, various modifications thereof will be apparent to those skilled in the art without departing from the spirit and scope of the invention as outlined in the claims appended hereto.

1. A method for enhancing capture of signals from a front-facing camera, the method comprising:
iteratively performing for a predetermined period:
displaying one or more user elements to a user on a display;
displaying a backlighting color at approximately maximum brightness at ancillary portions of the display, the ancillary portions comprising areas of the display that do not include the one or more user elements;
receiving data captured of the user from the front-facing camera; and
displaying representations of the data captured of the user within the one or more user elements; and
outputting the data captured of the user.

2. The method of claim 1, wherein the one or more user elements are substantially oblong shaped.

3. The method of claim 2, wherein the one or more user elements are oval shapes.

4. The method of claim 1, wherein the backlighting color is a solid color with greater brightness compared to other colors displayable by the display.

5. The method of claim 1, wherein displaying the backlighting color at approximately maximum brightness at ancillary portions of the display comprises displaying the backlighting color with high-dynamic range (HDR).

6. The method of claim 1, wherein displaying a backlighting color at approximately maximum brightness at ancillary portions of the display comprises dynamically adjusting brightness of the display and color temperature in the ancillary portions based on lighting condition and skin tone of the user.

7. The method of claim 1, further comprising, during each iteration, displaying to the user instructions for placement of the front-facing camera in front of the user based on position and distance of the user relative thereto.

8. The method of claim 1, further comprising outputting to the user a measure of signal quality determined from the data received from the front-facing camera.

9. The method of claim 8, wherein outputting to the user the measure of signal quality determined from the data received from the front-facing camera comprises displaying visual representations of the measure of signal quality.

10. The method of claim 9, wherein the visual representations of the measure of signal quality are displayed in the ancillary portion of the display.

11. A system for enhancing capture of signals from a front-facing camera, the system comprising:
a processor;
an interface operatively connected to the processor, wherein the interface is configured to receive input from the front-facing camera and to output information to a display; and
a storage medium operatively connected to the processor, the non-transitory readable storage medium stores instructions executable by the processor to:
iteratively:
display one or more user elements to a user on the display;
display a backlighting color at approximately maximum brightness at ancillary portions of the display, the ancillary portions comprising areas of the display that do not include the one or more user elements;
receive data captured of the user from the front-facing camera; and
display representations of the data captured of the user within the one or more user elements; and
output the data captured of the user.

12. The system of claim 11, wherein the one or more user elements are substantially oblong shaped.

13. The system of claim 12, wherein the one or more user elements are oval shapes.

14. The system of claim 11, wherein the backlighting color is a solid color with greater brightness compared to other colors displayable by the display.

15. The system of claim 11, wherein displaying the backlighting color at approximately maximum brightness at ancillary portions of the display comprises displaying the backlighting color with high-dynamic range (HDR).

16. The system of claim 11, wherein displaying a backlighting color at approximately maximum brightness at ancillary portions of the display comprises dynamically adjusting brightness of the display and color temperature in the ancillary portions based on lighting condition and skin tone of the user.

17. The system of claim 11, wherein, during each iteration, instructions for placement of the front-facing camera in front of the user is displayed to the user based on position and distance of the user relative thereto.

18. The system of claim 11, wherein, a measure of signal quality is outputted to the user that is determined from the data received from the front-facing camera.

19. The system of claim 18, wherein outputting to the user the measure of signal quality determined from the data received from the front-facing camera comprises displaying visual representations of the measure of signal quality.

20. The method of claim 19, wherein the visual representations of the measure of signal quality are displayed in the ancillary portion of the display.
